(19) United States
(12) Patent Application Publication
(10) Pub. No.: US 2024/0386111 A1
(43) Pub. Date: Nov. 21, 2024

(54) A Method of Training a Submodule and Preventing Capture of an AI Module

(71) Applicants: Robert Bosch GmbH, Stuttgart (DE); Robert Bosch Engineering and Business Solutions Private Limited, Bangalore (IN)

(72) Inventors: Manojkumar Somabhai Parmar, Ahmedabad, Gujarat (IN); Mayurbhai Thesia Yash, Ahmedabad, Gujarat (IN)

(21) Appl. No.: 18/704,134

(22) PCT Filed: Oct. 18, 2022
(86) PCT No.: PCT/EP2022/078971

§ 371 Date: Apr. 24, 2024

(30) Foreign Application Priority Data
Oct. 27, 2021 (IN) 2021 4104 8999

(51) Int. Cl. G06F 21/56

(52) U.S. Cl. CPC G06F 21/567

(57) ABSTRACT

A method of training a submodule and preventing capture of an AI module is disclosed. Input data received from an input interface is transmitted through a blocker module to an AI module, which computes a first output data by executing an AI model. A submodule in the AI system trained using methods steps processes the input data to identify an attack vector from the input data. The submodule distinguishes between a genuine input and an attack vector by identifying one or more non-robust features in the input. The identification information of the attack vector is sent to the information gain module.

### FIELD OF THE INVENTION

The present disclosure relates to a method of training a submodule in an AI system and a method of preventing capture of an AI module in the AI system.

### BACKGROUND OF THE INVENTION

With the advent of data science, data processing and decision making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

It is possible that some adversary may try to capture/copy/extract the model from AI systems. The adversary may use different techniques to capture the model from the AI systems. One of the simple techniques used by the adversaries is where the adversary sends different queries to the AI system iteratively, using its own test data. The test data may be designed in a way to extract internal information about the working of the models in the AI system. The adversary uses the generated results to train its own models. By doing these steps iteratively, it is possible to capture the internals of the model and a parallel model can be built using similar logic. This will cause hardships to the original developer of the AI systems. The hardships may be in the form of business disadvantages, loss of confidential information, loss of lead time spent in development, loss of intellectual properties, loss of future revenues etc.

There are methods known in the prior arts to identify such attacks by the adversaries and to protect the models used in the AI system. The prior art US 20190095629A1—Protecting Cognitive Systems from Model Stealing Attacks discloses one such method. It discloses a method wherein the input data is processed by applying a trained model to the input data to generate an output vector having values for each of the plurality of pre-defined classes. A query engine modifies the output vector by inserting a query in a function associated with generating the output vector, to thereby generate a modified output vector. The modified output vector is then output. The query engine modifies one or more values to disguise the trained configuration of the trained model logic while maintaining accuracy of classification of the input data.

### BRIEF DESCRIPTION OF THE ACCOMPANYING DRAWINGS

An embodiment of the invention is described with reference to the following accompanying drawings:

FIG. 1 depicts an AI system;

FIG. 2 illustrates method steps of training a submodule in an AI system; and

FIG. 3 illustrates method steps to prevent capturing of an AI module in an AI system.

### DETAILED DESCRIPTION OF THE DRAWINGS

It is important to understand some aspects of artificial intelligence (AI) technology and artificial intelligence (AI) based systems or artificial intelligence (AI) system. This disclosure covers two aspects of AI systems. The first aspect is related to the training of a submodule in the AI system and second aspect is related to the prevention of capturing of the AI module in an AI system.

Some important aspects of the AI technology and AI systems can be explained as follows. Depending on the architecture of the implements AI systems may include many components. One such component is an AI module. An AI module with reference to this disclosure can be explained as a component which runs a model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module and can be applied to any AI module irrespective of the AI model being executed. A person skilled in the art will also appreciate that the AI module may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. Clustering or grouping is the detection of similarities in the inputs. The cluster learning techniques do not require labels to detect similarities. Learning without labels is called unsupervised learning. Unlabeled data is the majority of data in the world. One law of machine learning is: the more data an algorithm can train on, the more accurate it will be. Therefore, unsupervised learning models/algorithms has the potential to produce accurate models as training dataset size grows.

As the AI module forms the core of the AI system, the module needs to be protected against attacks. Attackers attempt to attack the model within the AI module and steal information from the AI module. The attack is initiated through an attack vector. In the computing technology a vector may be defined as a method in which a malicious code/virus data uses to propagate itself such as to infect a computer, a computer system or a computer network. Similarly an attack vector is defined a path or means by which a hacker can gain access to a computer or a network in order to deliver a payload or a malicious outcome. A model stealing attack uses a kind of attack vector that can make a digital twin/replica/copy of an AI module.

The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is black box model attack vector where no prior knowledge of original model is required. As the prior information regarding model is available and increasing, attacker moves towards more intelligent attacks. The attacker chooses relevant dataset at his disposal to extract model more efficiently. This is domain intelligence model-based attack vector. With these approaches, it is possible to demonstrate model stealing attack across different models and datasets.

It must be understood that the disclosure in particular discloses methodology used for training a submodule in an AI system and a methodology to prevent capturing of an AI module in an AI system. While these methodologies describes only a series of steps to accomplish the objectives, these methodologies are implemented in AI system, which may be a combination of hardware, software and a combination thereof.

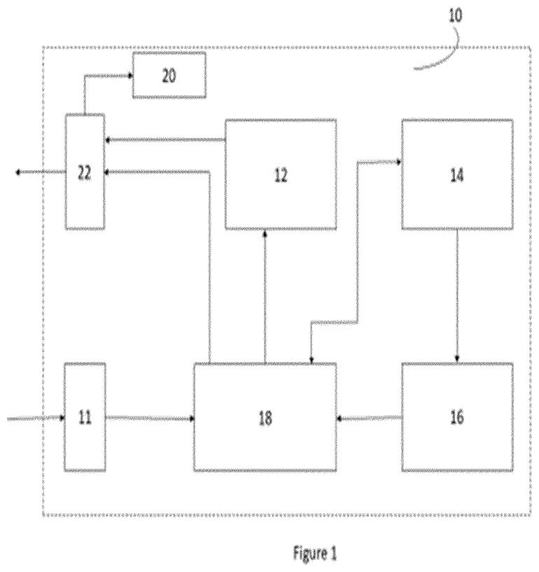

FIG. 1 depicts an AI system (10). The AI system (10) comprises an input interface (11), a blocker module (18), an AI module (12), a submodule (14), a blocker notification module (20), an information gain module (16) and at least an output interface (22). The input interface (11) receives input data from at least one user. The input interface (11) is a hardware interface wherein a used can enter his query for the AI module (12).

A module with respect to this disclosure can either be a logic circuitry or a software programs that respond to and processes logical instructions to get a meaningful result. A hardware module may be implemented in the system as one or more microprocessors, microcomputers, microcontrollers, digital signal processors, central processing units, state machines, logic circuitries, and/or any component that operates on signals based on operational instructions. As explained above, these various modules can either be a software embedded in a single chip or a combination of software and hardware where each module and its functionality is executed by separate independent chips connected to each other to function as the system. For example, a neural network (in an embodiment the AI module) mentioned herein after can be a software residing in the system or the cloud or embodied within an electronic chip. Such neural network chips are specialized silicon chips, which incorporate AI technology and are used for machine learning.

The blocker module (18) is configured to block a user when the information gain. Information gain is calculated based on input attack queries exceeds a predefined threshold value. The blocker module (18) is further configured to modify a first output generated by an AI module (12). This is done only when the input is identified as an attack vector.

The AI module (12) to process said input data and generate the first output data corresponding to said input. The AI module (12) executes a first model (M) based on the input to generate a first output. This model could be any from the group of artificial neural networks, convolutional neural networks, recurrent neural networks and the like.

The submodule (14) configured to identify an attack vector from the received input data. The submodule uses an unsupervised machine learning defense mechanism to identify an attack vector. This submodule could again run an AI model could be any from the group of artificial neural networks, convolutional neural networks, recurrent neural networks and the like. The submodule distinguishes between a genuine input and an attack vector by identifying one or more non-robust features in the input. A non-robust feature in machine language is defined as a feature derived from patterns in the data distribution that are highly predictive, yet brittle and thus incomprehensible to humans. In other words robust features are human-specific and easily identifiable by the human mind whereas a non-robust feature is derived from patterns in the data distribution that depend entirely on the Deep learning model, training data, relative class labels and others. Mathematically distribution of these robust and non-robust features has been elaborated in a paper titled “Adversarial examples are not bugs, they are features.”¹ 1 Ilyas, A., Santurkar, S., Tsipras, D., Engstrom, L., Tran, B. and Madry, A., 2019. Adversarial examples are not bugs, they are features. arXiv preprint arXiv: 1905.02175.

The blocker notification module (20) transmits a notification to the owner of said AI system (10) on detecting an attack vector. The notification could be transmitted in any audio/visual/textual form.

The information gain module (16) is configured to calculate an information gain and send the information gain value to the blocker module (18). The information gain is calculated using the information gain methodology. In one embodiment, if the information gain extracted exceeds a pre-defined threshold, the AI system (10) is configured to lock out the user from the system. The locking out the system is initiated if the cumulative information gain extracted by plurality of users exceeds a pre-defined threshold.

The output interface (22) is sends output to said at least one user. The output sent by the output interface (22) comprises the first output data when the submodule (14) doesn't identify an attack vector from the received input. The output sent by the output interface (22) comprises a modified output received from the blocker module (18), when an attack vector is detected from the input.

It must be understood that each of the building blocks of the AI system (10) may be implemented in different architectural frameworks depending on the applications. In one embodiment of the architectural framework all the building block of the AI system (10) are implemented in hardware i.e. each building block may be hardcoded onto a microprocessor chip. This is particularly possible when the building blocks are physically distributed over a network, where each building block is on individual computer system across the network. In another embodiment of the architectural framework of the AI system (10) are implemented as a combination of hardware and software i.e. some building blocks are hardcoded onto a microprocessor chip while other building block are implemented in a software which may either reside in a microprocessor chip or on the cloud.

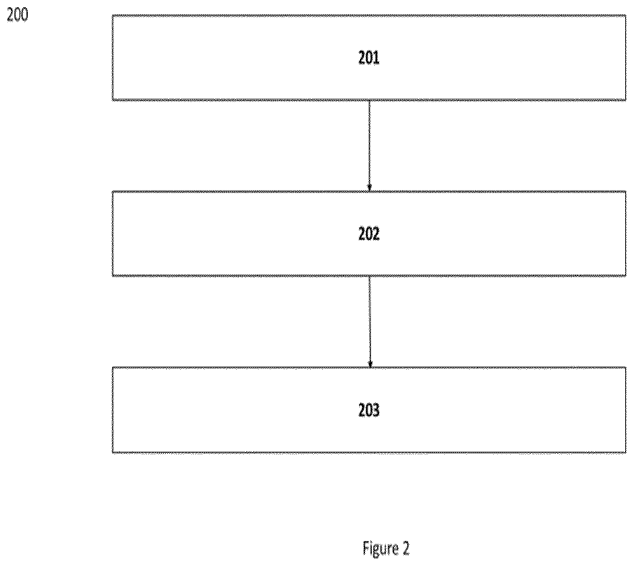

FIG. 2 illustrates method steps (200) of training a submodule (14) in an AI system (10). The AI system (10) comprises the components described above in FIGS. 1 and 2. The submodule (14) is trained using a dataset used to train the AI module (12). The submodule (14) is trained using a dataset used to train the AI module (12).

Method step 201 comprises defining at least one secondary task that can be performed on the dataset. Method step 202 comprises executing the submodule with the dataset. Method step 203 comprises recording an output of the secondary task to identify a non-robust feature. The identification of one or more non-robust features in the dataset is used to determine an attack vector.

This can be explained with an example as an embodiment of the present invention. Let us assume the primary task is the Face recognition model, the dataset comprises images of faces and the secondary task is to classify whether the face is in the image or not (face identification). After the submodule is trained on the on original (training) dataset, we pass the attack vector and find out the output of secondary task. If we are not able to find any primary features using the submodule means and absence of a human recognizable face i.e. a robust feature. If submodule recognizes a pattern in the data distribution of the input that are highly predictive but not recognizable to a human mind i.e. a non-robust feature, we determine the presence of an attack vector in the dataset.

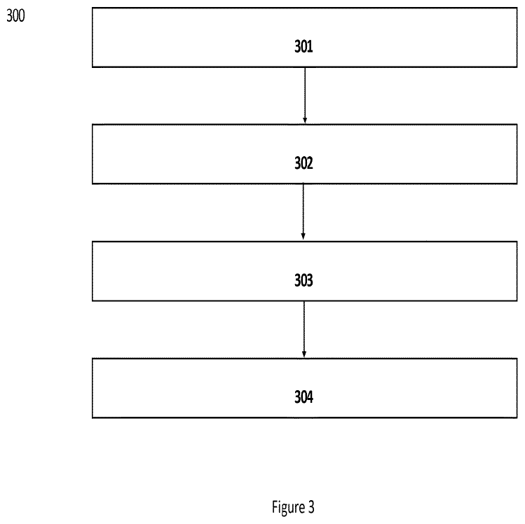

FIG. 3 illustrates method steps (300) to prevent capturing of an AI module (12) in an AI system (10). The AI system (10) and its components have been explained in the preceding paragraphs by means of FIGS. 1 and 2. A person skilled in the art will understand that the submodule (14) trained by the method steps (200) is now used in real time for preventing capture of an AI module (12) in an AI system (10).

In method step 301, input interface (11) receives input data from at least one user. In step 302, this input data is transmitted through a blocker module (18) to an AI module (12). In step 303, the AI module (12) computes a first output data by the AI module (12) executing a first model (M) based on the input data.

In step 304, input is processed by submodule (14) to identify an attack vector from the input data, the identification information of the attack vector is sent to the information gain module (16). The processing by the submodule further comprises defining at least one secondary task that can be performed on the input data; executing the submodule with the input data; recording an output of the secondary task to identify a non-robust feature. The identification of one or more non-robust features in the dataset is used to determine an attack vector.

Once the attack vector identification information is sent to the information gain module (16), an information gain is calculated. The information gain is sent to the blocker module (18). In an embodiment, if the information gain exceeds a pre-defined threshold, the user is blocked and the notification is sent the owner of the AI system (10) using blocker notification module (20). If the information gain is below a pre-defined threshold, although an attack vector was detected, the blocker module (18) may modify the first output generated by the AI module (12) to send it to the output interface (22).

In addition the user profile may be used to determine whether the user is habitual attacker or was it one time attack or was it only incidental attack etc. Depending upon the user profile, the steps for unlocking of the system may be determined. If it was first time attacker, the user may be locked out temporarily. If the attacker is habitual attacker, then a stricter locking steps may be suggested.

It must be understood that the embodiments explained in the above detailed description are only illustrative and do not limit the scope of this invention. Any modification to a method of training a submodule (14) and preventing capture of an AI module (12) are envisaged and form a part of this invention. The scope of this invention is limited only by the claims.

1. An AI system, comprising:
an input interface configured to receive input from at least one user;
a blocker module configured to block at least one user;
an AI module configured to process said input data and generate first output data corresponding to said input;
a submodule configured to identify an attack vector from the received input;
an information gain module configured to calculate an information gain and send the information gain value to the blocker module;
a blocker notification module configured to transmit a notification to the owner of said AI system on detecting an attack vector, the blocker notification module further configured to modify a first output generated by an AI module; and
an output interface configured to send an output to said at least one user.

2. The AI system as claimed in claim 1, where the output sent by the output interface comprises the first output data when the submodule doesn't identify an attack vector from the received input.

3. The AI system as claimed in claim 1, wherein the submodule is configured to distinguish between a genuine input and an attack vector by identifying one or more non-robust features in the input.

4. A method of training a submodule in an AI system, said AI system comprising at least an AI module, and a dataset used to train the AI module, said method comprising:
defining at least one secondary task that can be performed on the dataset;
executing the submodule with the dataset; and
recording an output of the secondary task to identify a non-robust feature.

5. The method of training a submodule in an AI system as claimed in claim 4, wherein identification of one or more non-robust features in the dataset is used to determine an attack vector.

6. A method to prevent capturing of an AI module in an AI system, comprising:
receiving input data from at least one user through an input interface;
transmitting input data through a blocker module to an AI module;
computing a first output data by the AI module based on the input data; and
processing input data by a submodule to identify an attack vector from the input data, the identification information of the attack vector being sent to the information gain module.

7. The method to prevent capturing of an AI module in an AI system as claimed in claim 6, wherein processing the input data further comprises:
defining at least one secondary task that can be performed on the input data;
executing the submodule with the input data; and
recording an output of the secondary task to identify a non-robust feature.

8. The method to prevent capturing of an AI module in an AI system as claimed in claim 6, wherein identification of one or more non-robust features in the dataset is used to determine an attack vector.
